(19) United States
(12) Patent Application Publication
(10) Pub. No.: US 2025/0106700 A1
(43) Pub. Date: Mar. 27, 2025

(54) METHOD AND APPARATUS FOR NODE MOVEMENT AND CORRESPONDING NODE

(71) Applicant: Samsung Electronics Co., Ltd., Gyeonggi-do (KR)

(72) Inventors: Weiwei WANG, Beijing (CN); Hong WANG, Beijing (CN); Lixiang XU, Beijing (CN)

(21) Appl. No.: 18/730,110

(22) PCT Filed: Dec. 26, 2022
(86) PCT No.: PCT/KR2022/021291

§ 371 Date: Jul. 18, 2024

(30) Foreign Application Priority Data
Jan. 19, 2022 (CN) 202210059900.8
Dec. 8, 2022 (KR) 10-2022-0170271

(51) Int. Cl. H04W 36/00; H04W 36/08

(52) U.S. Cl. CPC H04W 36/0055; H04W 36/08

(57) ABSTRACT

The disclosure relates to a 5G or 6G communication system for supporting a higher data transmission rate. The application provides a method in a communication system, comprising: transmitting at least one of: candidate information related to cell selection, first data configuration information, update configuration indication information, and configuration indication information, and/or receiving at least one of: assistance information related to cell selection, second data configuration information, and third information related to configuration.

### TECHNICAL FIELD

The present disclosure relates to a communication field, and in particular, relates to a radio communication method, a first node, user equipment, a third node, an electronic apparatus and a storage medium.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem

The present invention has been made to address at least the above problems and/or disadvantages and to provide at least the advantages described below. Accordingly, an aspect of the present invention provides a mechanism of node movement and corresponding nod.

### Solution to Problem

According to an embodiment of the disclosure, a method performed by a first network node in a communication system is provided, comprising: transmitting, to a second network node, at least one of: candidate information related to cell selection, first data configuration information, update configuration indication information, and configuration indication information, and/or receiving, from the second network node, at least one of: assistance information related to cell selection, second data configuration information, and third information related to configuration.

In an implementation, wherein the first data configuration information is at least one of: data configuration update request information, which is information for notifying the second network node of data for which the configuration is requested to update, information of data to be served, information of data to be newly created, the second data configuration information is at least one of: information of accepted data, information of rejected data, information of data to be configured, information of data accepted to be newly created, information of data rejected to be newly created.

In an implementation, wherein: the information of the data includes at least one of: identification information of data, quality of service (QoS) information of data, indication information of a data type, address information, ingress backhaul channel identification information, egress backhaul channel identification information, ingress routing identification information, egress routing identification information, header indication information, which is used to indicate information that needs to be added in a data header.

In an implementation,, wherein: data identified by the identification information of the data includes at least one of the following types: data on one or more bearers, data on one or more tunnels, F1 interface control signaling, F1 interface control signaling associated with a user, F1 interface control signaling not associated with a user, F1 interface user plane data, non-F1 interface data, data on one or more transport network layer (TNL) association, a type indicated by the indication information of the data type includes at least one of the following types: F1 interface control signaling, F1 interface control signaling associated with a user, F1 interface control signaling not associated with a user, F1 interface user plane data, non-F1 interface data.

In an implementation, wherein: the candidate information related to cell selection includes at least one of: identification information of a target node, information of a candidate serving node, identification information of a target cell, information of a candidate cell, the update configuration indication information includes at least one of: indication information of configuration change, configuration update information, including updated configuration information, access information, node configuration information, group update indication information, data transport configuration information, indication information for requesting migration, identification information of a target node, information of data to be migrated, the configuration indication information includes at least one of: first interface information, first information of a connected node, including at least one of identification information and address information of the connected node connected to a node, service area indication information, request information for a migration method, the assistance information related to cell selection includes at least one of: node configuration information, identification information of a serving node, identification information of a serving cell, information of a selectable serving node, information of a selectable cell, the third information related to the configuration includes at least one of: second interface information, response information of a migration method.

In an implementation, wherein the service area includes one or more nodes or one or more cells, and the nodes or nodes to which the cells included in the service area belong can interact with each other to configure data transport of another node.

In an implementation, wherein: the information of the candidate cell includes at least one of: identification information of a cell, measurement result information of a cell, information of cell load, identification information of a base station where the cell is located, the indication information of the configuration change includes at least one of: indication information of node change, indication information of transport reconfiguration, request indication information for transport reconfiguration, indication information of data for transport reconfiguration, the configuration update information includes at least one of: address information of a distributed unit of a base station, address information of a parent node, the access information includes at least one of: identification information of a cell, identification information of a serving node, the node configuration information, the first interface information, or the second interface information is used to indicate identification information of a node, and includes at least one of: identification information of the node on an unrelated interface, identification information of a node where the unrelated interface is located, identification information of the node on a related interface, identification information of a node where the related interface is located, identification information of the node used for data transport configuration interaction, user identification information of a cell, identification information of a serving cell, the group update indication information includes at least one of: adaptation layer address update information, transport layer address update information, ingress backhaul channel update information, egress backhaul channel update information, ingress routing identification update information, egress routing identification update information, header indication update information, the data transport configuration information includes at least one of: header indication information, indicating information that needs to be added in a header, internet protocol (IP) address information, the information of the data to be migrated includes at least one of: indication information of data flow, indication information of a tunnel,
identification information of a bearer, address information of a transport layer, identification information of transport routing, address information of an adaptation layer.

In an implementation, wherein: the indication information of data for transport reconfiguration includes at least one of: indication information of data flow, indicating identification information of the data flow to which data that needs to be reconfigured belongs, indication information of a tunnel, indication information of transport network layer (TNL) association, identification information of a bearer, address information of a transport layer, identification information of transport routing, address information of an adaptation layer.

In an implementation, wherein the first network node is one of a first node as a relay node, a second node interfacing with the first node, a third node that is radio resource control (RRC) connected with the first node, and a fourth node that is RRC connected with the first node, and the second network node is one different from the first network node among the first node, the second node, the third node and the fourth node.

According to an embodiment of the disclosure, a method performed by a second network node in a communication system is provided, comprising: receiving, from a first network node, at least one of: candidate information related to cell selection, first data configuration information, update configuration indication information, and configuration indication information, and/or transmitting, to the first network node, at least one of: assistance information related to cell selection, second data configuration information, and third information related to configuration.

In an implementation, wherein: the first data configuration information is at least one of: data configuration update request information, which is information for notifying the second network node of data for which the configuration is requested to update, information of data to be served, information of data to be newly created, the second data configuration information is at least one of: information of accepted data, information of rejected data, information of data to be configured, information of data accepted to be newly created, information of data rejected to be newly created.

In an implementation, wherein: the information of the data includes at least one of: identification information of data, quality of service (QoS) information of data, indication information of a data type, address information, ingress backhaul channel identification information, egress backhaul channel identification information, ingress routing identification information, egress routing identification information, header indication information, which is used to indicate information that needs to be added in a data header.

In an implementation, wherein: data identified by the identification information of the data includes at least one of the following types: data on one or more bearers, data on one or more tunnels, F1 interface control signaling, F1 interface control signaling associated with a user, F1 interface control signaling not associated with a user, F1interface user plane data, non-F1 interface data, data on one or more transport network layer (TNL) association, a type indicated by the indication information of the data type includes at least one of the following types: F1 interface control signaling, F1 interface control signaling associated with a user, F1 interface control signaling not associated with a user, F1 interface user plane data, non-F1 interface data.

In an implementation, wherein: the candidate information related to cell selection includes at least one of: identification information of a target node, information of a candidate serving node, identification information of a target cell, information of a candidate cell, the update configuration indication information includes at least one of: indication information of configuration change, configuration update information, including updated configuration information, access information, node configuration information, group update indication information, data transport configuration information, indication information for requesting migration, identification information of a target node, information of data to be migrated, the configuration indication information includes at least one of: first interface information, first information of a connected node, including at least one of identification information and address information of the connected node connected to a node, service area indication information, request information of a migration method, the assistance information related to cell selection includes at least one of: node configuration information, identification information of a serving node, identification information of a serving cell, information of a selectable serving node, information of a selectable cell, the third information related to the configuration includes at least one of: second interface information, response information of a migration method.

In an implementation, wherein the service area includes one or more nodes or one or more cells, and the nodes or nodes to which the cells included in the service area belong can interact with each other to configure data transport of another node.

In an implementation, wherein: the information of the candidate cell includes at least one of: identification information of a cell, measurement result information of a cell, information of cell load, identification information of a base station where the cell is located, the indication information of the configuration change includes at least one of: indication information of node change, indication information of transport reconfiguration, request indication information for transport reconfiguration, indication information of data for transport reconfiguration, the configuration update information includes at least one of: address information of a distributed unit of a base station, address information of a parent node, the access information includes at least one of: identification information of a cell, identification information of a serving node, the node configuration information, the first interface information, or the second interface information is used to indicate identification information of a node, and includes at least one of: identification information of the node on an unrelated interface, identification information of a node where the unrelated interface is located, identification information of the node on a related interface, identification information of a node where the related interface is located, identification information of the node used for data transport configuration interaction, user identification information of a cell, identification information of a serving cell, the group update indication information includes at least one of: adaptation layer address update information, transport layer address update information, ingress backhaul channel update information, egress backhaul channel update information, ingress routing identification update information, egress routing identification update information, header indication update information, the data transport configuration information includes at least one of: header indication information, indicating information that needs to be added in a header, IP address information, the information of the data to be migrated includes at least one of: indication information of data flow, indication information of a tunnel, identification information of a bearer, address information of a transport layer, identification information of transport routing, address information of an adaptation layer.

In an implementation, wherein: the indication information of data for transport reconfiguration includes at least one of: indication information of data flow, indicating identification information of the data flow to which data that needs to be reconfigured belongs, indication information of a tunnel, indication information of transport network layer (TNL) association, identification information of a bearer, address information of a transport layer, identification information of transport routing, address information of an adaptation layer.

In an implementation, wherein the first network node is one of a first node as a relay node, a second node interfacing with the first node, a third node that is RRC connected with the first node, and a fourth node that is RRC connected with the first node, and the second network node is one different from the first network node among the first node, the second node, the third node and the fourth node.

According to an embodiment of the disclosure, a first network node in a communication system is provided, comprising: a transceiver; and a processor coupled to the transceiver and configured to perform any of the methods according to the embodiments of the disclosure.

According to an embodiment of the disclosure, a second network node in a communication system is provided, comprising: a transceiver; and a processor coupled to the transceiver and configured to perform any of the methods according to the embodiments of the disclosure.

### ADVANTAGEOUS EFFECTS OF INVENTION

Advantages, and salient features of the invention will become apparent to those skilled in the art from the following detailed description, which, taken in conjunction with the annexed drawings, discloses exemplary embodiments of the invention. Accordingly present invention, node movement can be performed efficiently.

### BRIEF DESCRIPTION OF DRAWINGS

FIG. 1 is an example of an exemplary system architecture;

FIG. 2 is an exemplary system architecture according to various embodiments of the disclosure;

FIG. 3 is an example of a base station structure;

FIG. 4 is an example of a relay network;

FIG. 5 is an example of inter-topology data transport;

FIG. 6 is an example of a scenario;

FIG. 7 is an example of a first process;

FIG. 8 is an example of a second process;

FIG. 9 is an example of a third process;

FIG. 10 is an example of a fourth process;

FIG. 11 is an example of a fifth process;

FIG. 12 is an example of a sixth process;

FIG. 13 is an example of a seventh process;

FIG. 14 is an example of an eighth process; and

FIG. 15 is a schematic block diagram of a node according to an embodiment of the disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

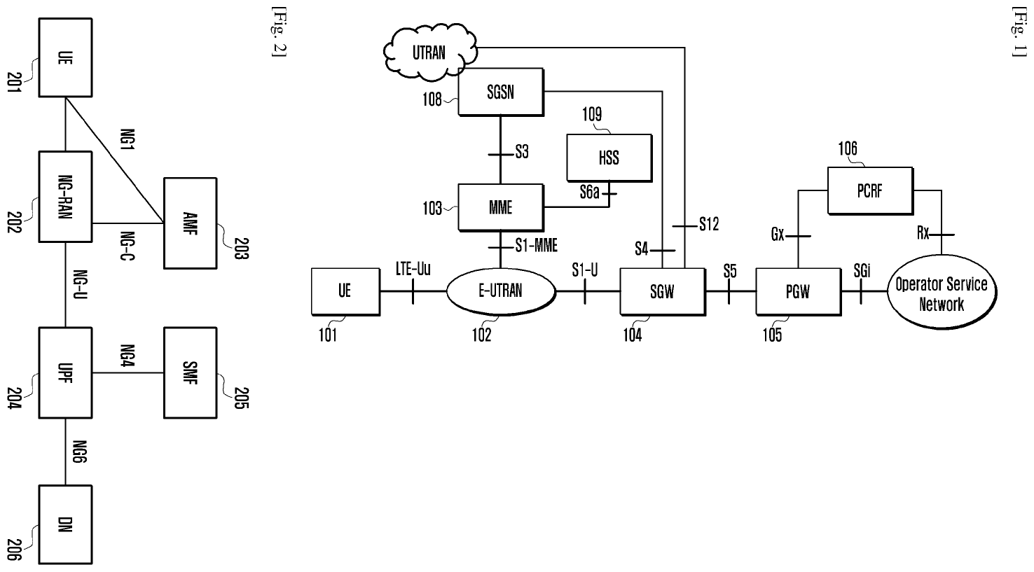

FIGS. 1 to 15 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transport in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

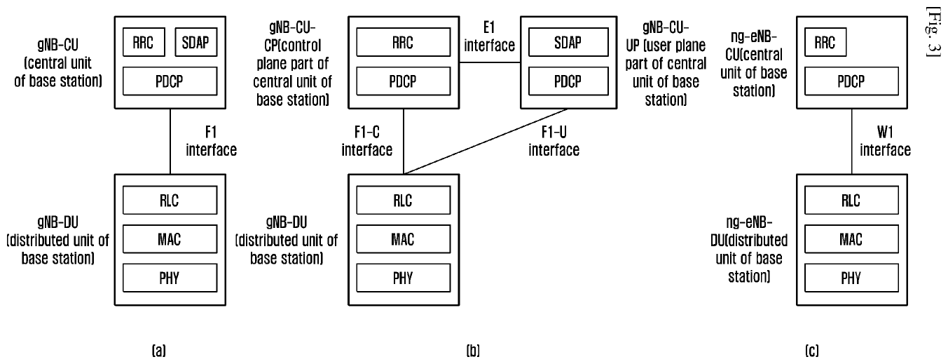

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

In an NR (New Radio access) network, in order to extend the coverage of the network, an architecture of a relay network, namely IAB (Integrated Access and Backhaul), is proposed. The architecture introduces a donor/anchor node and a relay node (e.g., IAB node). The donor node may be an independent base station, or a base station composed of a central unit CU (IAB-donor central unit) and a distributed unit DU (IAB-donor distributed unit). The relay node includes a Mobile terminal function and a Distributed terminal function (in another example, it may also be described that the relay node includes a mobile terminal part and a distributed unit part), wherein the mobile terminal function is used to communicate with an upper-level node of the relay node, the distributed unit part is used to communicate with a lower-level node of the relay node, and a connection is established between the distributed unit part and the donor node and serves users accessing the distributed unit part. The network containing the IAB node is a relay network. In order to further expand the coverage of the network, the current research begins to consider movement of the relay node, for example, a relay node is deployed on a vehicle, so that the relay node can provide services for users on this vehicle.

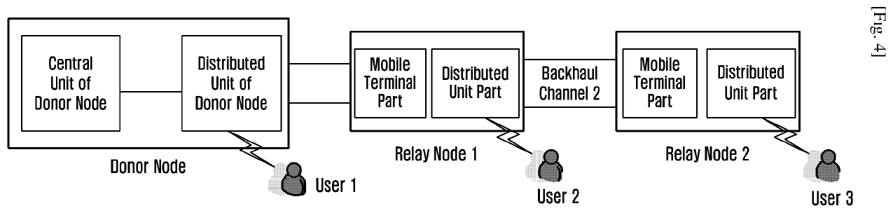

In an NR system, in order to support network function virtualization, more efficient resource management and scheduling, a base station (gNB/ng-eNB) providing wireless network interface for a terminal (UE) may be further divided into a central unit gNB-CU/ng-eNB-CU (gNB central unit/ng-eNB central unit) and a distributed unit gNB-DU/ng-eNB-DU (gNB distributed unit/ng-eNB distributed unit) (abbreviated as CU and DU in the invention), as shown in FIG. 3(a). The gNB-CU has radio resource control (RRC), service data adaptation protocol (SDAP) and packet data convergence protocol (PDCP) protocol layers, and the like, and the ng-eNB-CU has RRC and PDCP layers. The gNB-DU/ng-eNB-DU has radio link control protocol (RLC), medium access control (MAC) and physical layers, and the like. There is a standardized public interface F1 between gNB-CU and gNB-DU, and a standardized public interface W1 between ng-eNB-CU and ng-eNB-DU. The F1 interface is divided into a control plane F1-C and a user plane F1-U. The transport network layer of F1-C is based on IP transmission. In order to transmit signaling more reliably, SCTP protocol is added above the IP. The application layer protocol is F1AP, seeing 3GPP TS38.473. SCTP may provide reliable application layer message transmission. The transport layer of F1-U is UDP/IP, and GTP-U is above UDP/IP and used to carry user plane protocol data unit (PDU). Furthermore, as shown in FIG. 3(b), the gNB-CU may include gNB-CU-CP (a control plane part of the central unit of the base station) and gNB-CU-UP (a user plane part of the central unit of the base station). The gNB-CU-CP contains the function of the control plane of the base station and has RRC and PDCP protocol layers, and gNB-CU-UP contains the function of the user plane of the base station and has SDAP and PDCP protocol layers. There is a standardized public interface E1 between gNB-CU-CP and gNB-CU-UP, and the protocol is E1AP, seeing 3GPP TS38.463. The interface between the control plane part of the central unit of the base station and the distributed unit of the base station is F1-C interface, that is, a control plane interface of F1, and the interface between the user plane part of the central unit of the base station and the distributed unit of the base station is F1-U interface, that is, a user plane interface of F1. In addition, in the NR system, the base station which provides E-UTRA user plane and control plane and accesses to a 5G core network is called ng-eNB. In order to support virtualization, such base station (ng-eNB) may also be further divided into a central unit ng-eNB-CU (gNB central unit/ng-eNB central unit) and a distributed unit ng-eNB-DU (abbreviated as CU and DU in the invention), as shown in FIG. 3(c). The ng-eNB-CU has RRC and PDCP layers. The gNB-DU/ng-eNB-DU has radio link control protocol (RLC), medium access control (MAC) and physical layers, and the like. There is a standardized public interface W1 between ng-eNB-CU and ng-eNB-DU. W1 interface is divided into a control plane W1-C and a user plane W1-U. The transport network layer of W1-C is based on IP transmission. In order to transmit signaling more reliably, SCTP protocol is added above the IP. The application layer protocol is W1AP, seeing 3GPP TS37.473. The transport layer of W1-U is UDP/IP, and GTP-U is above UDP/IP and used to carry user plane protocol data unit (PDU).

FIG. 4 illustrates a schematic architecture of a multi-hop relay network (IAB network), which shows a network architecture including a donor node (such as IAB donor/anchor) and two relay nodes (such as IAB node). Users in the multi-hop network may access the network through the donor node or the distributed unit of the donor node or the relay node. For example, user 1/2/3 accesses the relay network through the distributed unit of the donor node, the distributed unit of relay node 1 and the distributed unit of relay node 2 respectively. The mobile terminal function of the relay node is used to communicate with the upper-level node of the relay node (for example, the mobile terminal part of relay node 1 is used to communicate with the donor node or the distributed unit of donor node, and the mobile terminal part of relay node 2 is used to communicate with the distributed unit part of relay node 1), and the distributed unit part of the relay node is used to communicate with the lower-level node of the relay node (for example, the distributed unit part of relay node 1 is used to communicate with user 2 or the mobile terminal part of relay node 2). The mobile terminal part of the relay node may be regarded as a user accessing the network, so it has the function of a normal user (non-relay node) (for example, the mobile terminal part may establish SRB with its upper-level node to transmit RRC messages, or establish DRB to transmit data). Protocol stacks included in the central unit of the donor node are: protocol stacks serving the control plane including a radio resource control (RRC) protocol layer and a packet data convergence protocol (PDCP) layer, and protocol stacks servicing the user plane including an SDAP (Service Data Adaptation Protocol) layer and a PDCP layer. Protocol stacks included in the distributed unit of the donor node or the distributed unit part of the relay node are: protocol stacks serving the control plane and the user plane including the radio link control (RLC) protocol layer, the medium access control (MAC) protocol layer, and the physical layer (PHY). The interfaces between the central unit of the donor node and the distributed unit of the donor node and interfaces between the central unit of the donor node and the distributed unit of the relay node are F1 interfaces (see 3GPP TS38.473).

In the relay network, the link between the relay node and the donor node or the distributed unit of the donor node, or between relay nodes is a backhaul link, and one or more different backhaul channels will be established on the backhaul link, such as backhaul channel 1 and backhaul channel 2 in FIG. 4. An example of the backhaul channel is a backhaul Radio Link Control (RLC) protocol layer channel, that is, a backhaul RLC channel. In the relay network, each backhaul channel will be used to transmit packets belonging to the same user or different users. The packet may be a user data radio bearer (DRB) packet, a user signaling radio bearer (SRB) packet, a control plane packet on the F1 interface, a user plane packet on the F1 interface, or a non-F1 interface packet (such as IPSec packet, SCTP protocol packet, OAM packet, etc.).

In order to realize the transmission of user data in multi-hop relay network, 3GPP defines a new protocol layer, that is, Backhaul Adaptation Layer (BAP), which will be configured in the distributed unit of the donor node and the relay node (such as the mobile terminal part of the relay node and/or the distributed unit part of the relay node) and above the RLC layer, and its main function is to route and map packets. In order to transmit user data between the relay node and the donor node, it is necessary to complete the configuration of the backhaul link and the configuration of F1 interface between the distributed unit part of the relay node and the donor node. Such configuration includes, but is not limited to, the following types, such as BAP address, routing configuration (such as routing identification information, which indicates different transmission routes, and includes the BAP address and path identification of the destination receiving node), the configuration of the backhaul channel, the configuration of a tunnel, and the backhaul link configuration for the tunnel, etc.

After NR enters the relay network, the main consideration is the scenario where the relay node is fixed. However, with the further development of the research, the latest research has begun to consider the movement of the relay node. In the process of moving, the relay node needs to change the connected donor node frequently. Since many users may be connected to the relay node, such movement will inevitably lead to a large signaling overhead and interrupt the transmission of user data. To solve this problem, the existing scheme is to connect the distributed unit part of the relay node to the same donor node, while the mobile terminal part of the relay node changes its serving cell. In this way, the signaling overhead related to the distributed unit part can be saved, and the data interruption time can be reduced. However, this method is still given in the case where the relay node does not move. After the relay node moves, this method may lead to the possibility that the data transmission of the relay node cannot be configured. This is because the change of the serving cell of the mobile terminal of the relay node and the control of the distributed unit of the relay node are managed by two different entities. In this way, if the mobile terminal part of the relay node moves to a node unknown to a node to which the distributed unit of the relay node is connected, the data transmission of the relay node cannot be configured. This is the technical problem that the invention wants to solve, that is, how to ensure the continuous data transport between the distributed unit part of the relay node and the central unit part of the connected donor node during the movement of the relay node.

Exemplary embodiments of the disclosure are further described below with reference to the accompanying drawings.

The text and drawings are only provided as examples to help understand the disclosure. They should not be construed as limiting the scope of the disclosure in any way. Although some embodiments and examples have been provided, based on the disclosure herein, it is obvious to those skilled in the art that changes can be made to the illustrated embodiments and examples without departing from the scope of the disclosure.

Before introducing the specific content, some assumptions and some definitions of the invention are given below.
The message names in the invention are only examples, and other message names may be used.
The “first” and “second” included in the message names of the invention are only examples of the messages, and do not represent the performing order.
The detailed description of steps unrelated to the invention is omitted in the invention.
In the invention, the steps in each process may be performed in combination with each other or independently. The performing steps of each process are only examples, and other possible performing orders are not excluded.
In the invention, the base station may be a 5G base station (such as gNB, ng-eNB), a 4G base station (such as eNB), or other types of access nodes.
In the invention, data transport refers to reception or transmission of data.
In the invention, uplink data refers to the data transmitted by the relay node to the base station (donor node), and downlink data refers to the data transmitted by the base station (donor node) to the relay node.
In the invention, the structure of the relay node referred to in the solution description includes a mobile terminal part and a distributed unit part, and the interface between the distributed unit part of the relay node and the donor node (or the central unit part of the donor node) is F1 interface. However, the solution of the invention is also applicable to relay nodes with other structures. In an embodiment, another possible structure of the relay node is that it includes a mobile terminal part and a base station part, and the interface between the base station part and the donor node (or the central unit part of the donor node) is Xn/X2 interface.
In the invention, PCell (primary cell) is a cell that serves a node when the node is in a single connection (only connected with one node or distributed unit), and PSCell (primary secondary cell) is a cell where a secondary node serves the node when the node is in a dual connection.

The nodes to which the invention relates are:
a first node: a relay node including two parts, wherein a first part is used for the relay node to access the network, which is called a first entity of the first node, and a second part is used for serving other users, which is called a second entity of the first node. In an example, the relay node is an IAB node, that is, it includes an MT part and a DU part, so the first entity of the first node is the MT part and the second entity of the first node is the DU part. In another embodiment, the relay node is a node with a base station function, such as including an MT part and a base station part, so the first entity of the first node is an MT part and the second entity of the first node is a base station part.
a second node: a base station, or a central unit of the base station, or a control plane part of the central unit of the base station. The base station targeted by the second node is a node to which the first node is connected. In an embodiment, the second node is a node that establishes an RRC connection with the first node (or the first entity of the first node), and in another embodiment, the second node is a node that establishes an interface (such as F1 interface, Xn/X2 interface) with the first node (the second entity of the first node), and in another embodiment, the second node is a node that establishes both the interface and the RRC connection with the first node. Specifically, the second node may be a donor node of the first node, or a node with a donor node function.
a third node: a base station, or a central unit of the base station, or a control plane part of the central unit of the base station. The base station targeted by the third node is a node to which the first node is connected. In an embodiment, the third node is a node that establishes an RRC connection with the first node (or the first entity of the first node), and in another embodiment, the third node is a node that establishes an interface (such as F1 interface, Xn/X2 interface) with the first node (the second entity of the first node), and in another embodiment, the third node is a node that establishes both the interface and the RRC connection with the first node. Specifically, the third node may be a donor node of the first node, or a node with a donor node function.
a fourth node: the base station, or the central unit of the base station, or the control plane part of the central unit of the base station. The base station targeted by the fourth node is a node to which the first node is connected. In an embodiment, the fourth node is a node that establishes an RRC connection with the first node (or the first entity of the first node), and in another embodiment, the fourth node is a node that establishes an interface (such as F1 interface, Xn/X2 interface) with the first node (the second entity of the first node), and in another embodiment, the fourth node is a node that establishes both the interface and the RRC connection with the first node. Specifically, the fourth node may be a donor node of the first node, or a node with a donor node function.

In addition, the above second node, third node and fourth node may be different nodes, or any two of them may be the same node, or all three of them may be the same node. In the invention, the second node may be called an interface-termination node, and the third node or the fourth node may be called a non-interface-termination node.

In the following description, an example in which the first node is an IAB node is illustrated, so the interface established by the second entity of the first node is the F1 interface. However, the solution described in the invention is applicable to other types of relay nodes, and the following description about F1 interface is also applicable to other types of interfaces established between the second entity of the first node and the second/third/fourth node.

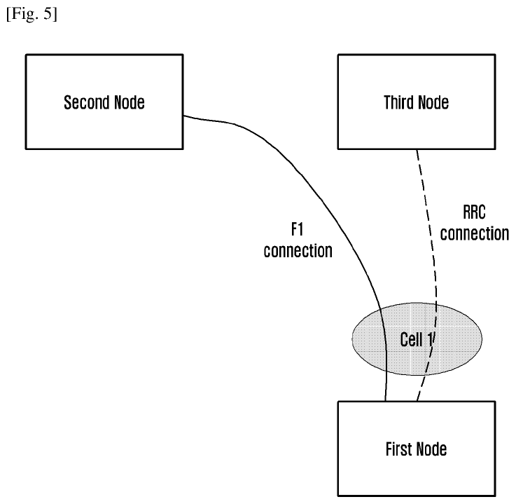

In the relay network, a possible connection mode is that a node to which the F1 interface of the relay node is terminated is different from a node to which the RRC connection of the relay node is terminated. As shown in FIG. 5, the F1 interface of the first node (relay node) is terminated to the second node (the F1 interface is established between the first node and the second node), and the RRC connection of the first node is terminated to the third node (the RRC connection is established between the first node and the third node). The data transport on the F1 connection and the RRC connection is completed through a cell controlled by the third node. The first node and the third node may be directly connected or connected through one or more intermediate nodes (such as the distributed unit of the base station, other relay nodes). In the invention, this data transport mode may be called inter-topology data transport or inter-network data transport: it indicates that the data transport between two nodes needs to be performed in the network (or topology) managed by other nodes. As shown in FIG. 5, data transport between the first node and the second node (such as data transport related to F1 interface) needs to be performed in the network managed by the third node (i.e. the network between the third node and the first node, which may include one or more intermediate nodes, such as relay nodes). In order to complete the data transport on the F1 interface, the third node needs to configure its communication link with the first node.

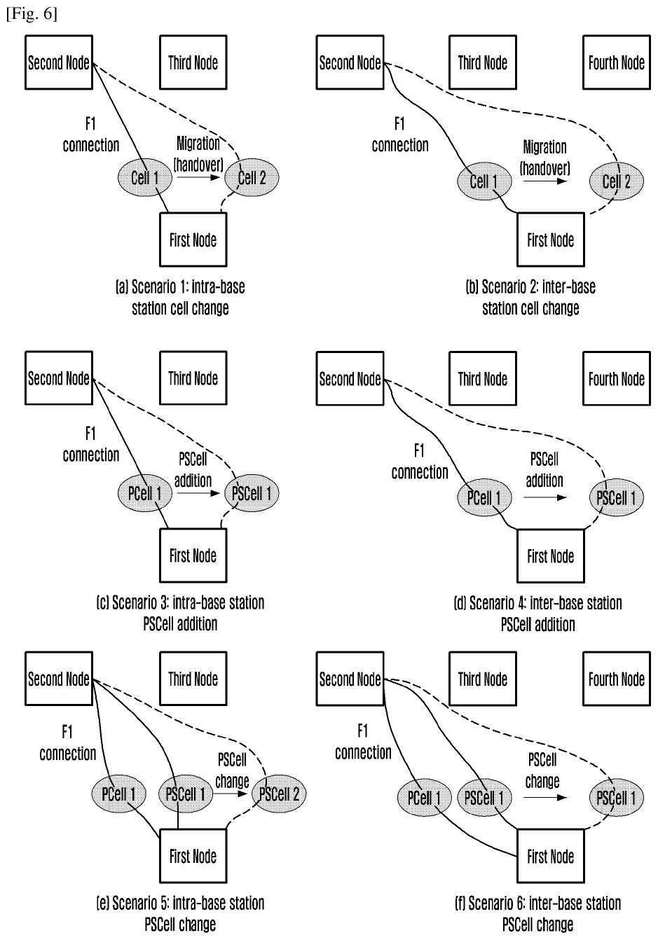

During the inter-topology data transport, the cell to which the first node is connected will be changed or increased, and the scenarios involved may include the following, as shown in FIG. 6:
a) scenario 1: intra-base station cell change
the cell accessed by the first node is changed. As shown in FIG. 6(a), the cell to which the first node is connected is changed from cell 1 to cell 2, and both cell 1 and cell 2 belong to the cells of the third node. Cell 1 and cell 2 may be regarded as PCells of the first node.
b) scenario 2: inter-base station cell change
the cell accessed by the first node is changed. As shown in FIG. 6(b), the cell to which the first node is connected is changed from cell 1 to cell 2, and cell 1 and cell 2 belong to the third node and the fourth node, respectively. Cell 1 and cell 2 may be regarded as PCells of the first node.
c) scenario 3: intra-base station PSCell increase
the cell accessed by the first node is added. As shown in FIG. 6(c), the third node adds a new cell for the first node, such as PSCell1. The addition of this cell enables the first node to establish a dual connection with a node under the third node.
d) scenario 4: inter-base station PSCell increase
the cell accessed by the first node is added. As shown in FIG. 6(d), the third node adds a new cell for the first node, such as PSCell1, and this new cell is a cell under the fourth node. The addition of this cell enables the first node to establish a dual connection with the third node and the fourth node.
e) scenario 5: intra-base station PSCell change
the cell accessed by the first node is changed. As shown in FIG. 6(e), the first node establishes a dual connection with a different node under the third node. In this scenario, the PSCell to which the first node is connected is changed, and this new PSCell still belongs to a cell controlled by the third node.
f) scenario 6: inter-base station PSCell change
the cell accessed by the first node is changed. As shown in FIG. 6(f), the first node establishes a dual connection with the third node and the fourth node. In this scenario, the PSCell to which the first node is connected is changed, and this new PSCell belongs to a cell controlled by the fourth node.

In the above scenarios, the serving cell of the first node is changed or added through the third node. For example, in scenarios 1 and 2, the third node initiates the cell change process, in scenarios 3 and 4, the third node initiates the PSCell addition process, and in scenarios 5 and 6, the third node initiates the PSCell change process. Such change or addition of cells will cause the configuration of data transport on the F1 interface between the first node and the second node to change, because the data transport of the F1 interface between the first node and the second node is performed through the cell accessed by the first node. If all the cells accessed by the first node belong to the third node, the data transport of the F1 interface needs to be configured through the third node; if all the cells accessed by the first node belong to the fourth node, the data transport of the F1 interface needs to be configured through the fourth node; if the cells accessed by the first node belong to the third and fourth nodes respectively, the data transport of the F1 interface needs to be configured by the third and fourth nodes. Further, these configurations need to be interacted to the second node, because the second node is a receiver or transmitter of data on the F1 interface, and the second node needs to configure the first node according to these configurations.

In order to support the first node to perform the above inter-topology data transport, it is necessary to perform configuration information interaction related to the data transport of the first node between base stations. For the convenience of description, the invention defines data configuration information, that is:
data configuration information, which at least includes one of:
identification information of data, which identifies configured data, such as identification information of data flow, tunnel identification, bearer identification, address information of transport layer, transport routing identification information, and address information of an adaptation layer. The data identified by the identification information may be one or more of the following types:
   data on one or more bearers
   data on one or more tunnels
   F1 interface control signaling
   F1 interface control signaling associated with a user
   F1 interface control signaling not associated with a user
   F1 interface user plane data
   Non-F1 interface data
   data on one or more transport network layer (TNL) association
QoS information of data
indication information of a data type, and the type indicated by the information may be one or more of the following types:
   F1 interface control signaling
   F1 interface control signaling associated with a user
   F1 interface control signaling not associated with a user
   F1 interface user plane data
   Non-F1 interface data
address information, which indicates the address information used to transport data, such as IP address and adaptation layer address. In an embodiment, the address information is address information of the first node side.
ingress backhaul channel identification information, such as Ingress BH RLC CH ID, which indicates the backhaul channel used to transmit data to the first node. In an embodiment, the backhaul channel is the channel used by the first node when receiving uplink data, and in another embodiment, the backhaul channel is the channel used by the first node when receiving downlink data.
egress backhaul channel identification information, such as Egress BH RLC CH ID, which indicates the backhaul channel used by the first node when transmitting data. In an embodiment, the backhaul channel is the channel used by the first node when transmitting downlink data, and in another embodiment, the backhaul channel is the channel used by the first node when transmitting uplink data.
ingress routing identification information, such as Ingress BAP routing ID, which indicates the BAP routing ID included in the data received by the first node. In an embodiment, the information is the route to which the uplink data received by the first node belongs, which may be contained in the uplink packet, and in another embodiment, the information is the route to which the downlink data received by the first node belongs, which may be contained in the downlink packet.
egress routing identification information, such as Egress BAP routing ID, which indicates the BAP routing ID added to the data when the first node transmits data. In an embodiment, the information is the route to which the uplink data transmitted by the first node belongs, which may need to be contained in the uplink packet, and in another embodiment, the information is the route to which the downlink data transmitted by the first node belongs, which may need to be contained in the downlink packet.
header indication information, which indicates the information that needs to be added in a data header, such as the setting of a DSCP field and a flow label field of an IP header.
the node that transmits the information may be a node that has an interface (such as F1 interface) with the relay node, or a node that has no an interface (such as F1interface) with the relay node. The information contains configuration information used when transporting data on the interface (F1 interface) of the relay node in the network managed by the transmitting node, or forwarded configuration information that is used when transporting data on the interface (F1 interface) of the relay node in the network managed by other nodes. In the above scenarios, in an example, the “data configuration information” is transmitted by the second node to the third or fourth node, in another example, the “data configuration information” is transmitted by the third or fourth node to the second node, in another example, the “data configuration information” is transmitted by the third node to the fourth node, or transmitted by the fourth node to the third node, in another example, the “data configuration information” is information forwarded by the third node that is from the fourth node, and in another example, the “data configuration information” is information forwarded by the third node that is from the second node. Furthermore, if the “data configuration information” is generated by a node that has an interface (such as F1 interface) with the relay node (if the information is information forwarded by the third node that is from the second node, it is also considered that the information is generated by a node having an interface with the relay node), the “ingress backhaul channel identification information” contained in the information is the channel used by the first node when receiving uplink data, “egress backhaul channel identification information” is the channel used by the first node when transmitting downlink data, and “ingress routing identification information” is the route to which the uplink data received by the first node belongs, which may be contained in the uplink packet, and “egress routing identification information” is the route to which the downlink data transmitted by the first node belongs, which may need to be contained in the downlink packet; if the “data configuration information” is generated by a node that has no interface (such as F1 interface) with the relay node (if the information is information forwarded by the third node that is from the fourth node, it is also considered that the information is generated by a node that has no interface with the relay node), the “ingress backhaul channel identification information” contained in the information is the channel used by the first node when receiving downlink data, “egress backhaul channel identification information” is the channel used by the first node when transmitting uplink data; “ingress routing identification information” is the route to which the downlink data received by the first node belongs, which may be contained in the downlink packet; “egress routing identification information” is the route to which the uplink data transmitted by the first node belongs, which may need to be contained in the uplink packet.

The invention relates to two migration methods of the relay node:
Partial migration: in this method, the data on the relay node is only partially migrated. In an embodiment, the RRC connection of the mobile terminal part of the relay node is migrated (for example, the cell to which the relay node is connected is changed), but the connection of the F1 interface of the distributed unit part of the relay node is not migrated. The partial migration is shown in FIG. 5.
Full migration: in this method, the data on the relay node is completely migrated. In an embodiment, the RRC connection of the mobile terminal part of the relay node is migrated (for example, the cell to which the relay node is connected is changed), and the connection of the F1 interface of the relay node is also migrated to the node of the cell serving the relay node.

The signaling process related to the invention may be regarded as the interaction between two network nodes (the first network node and the second network node), which may be respectively the second node and the third node, or the third node and the fourth node, or the second node and the fourth node, or the first node and the second node, and so on. This signaling interaction process is to configure relay nodes to perform inter-topology data transport. Specifically, this process is to configure the data between the relay node and donor node to be transmitted through the network managed by other nodes (that is, to configure the data of the relay node for internetwork (topology) transport).

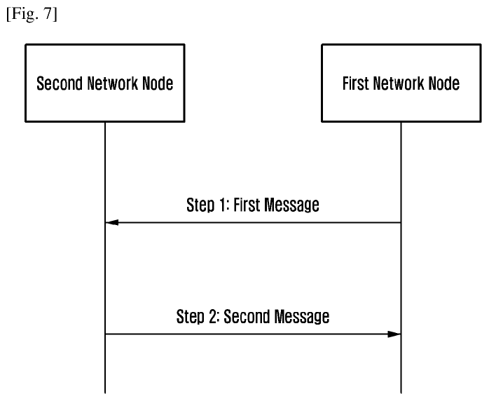

This signaling process may include the following two steps, as shown in FIG. 7:

Step 1: a first network node transmits a first message to a second network node. Based on different purposes, the message contains the following content:
(1) providing candidate information of a target cell for the second network node, wherein the first message at least includes one of (step 1-a-1):
   identification information of a target node
   information of a candidate serving node
   identification information of a target cell
   information of a candidate cell
(2) providing first indication information for updating a configuration of the second network node, wherein the indication information is for updating configuration information of a relay node served by the second network node, and the first message at least includes one of (step 3-a-1, step 4-1, or step 3-c-1, step 3-b-1):
   indication information of configuration change, such as first indication information of configuration change, second indication information of configuration change and third indication information of configuration change.
   configuration update information, such as first configuration update information, second configuration update information and third configuration update information
   access information, such as first access information, second access information and third access information
   node configuration information, such as first configuration information of node, second configuration information of node and third configuration information of node.
   data configuration update request information, such as first data configuration update request information and third data configuration update request information
   group update indication information, such as first group update indication information and the third group update indication information
   data transport configuration information, such as first data transport configuration information, second data transport configuration information and third data transport configuration information
   indication information for requesting migration
   identification information of a target node
   information of data to be migrated
(3) providing first configuration indication information for the second network node, wherein the indication information is to configure a serving cell of the relay node, and the first message at least includes one of (step 2-1):
   data information of a first node
   information of data to be newly created
   first interface information
   first information of a connected node
   service area indication information
   request information of a migration method

Step 2: the second network node transmits a second message to the first network node. Based on different purposes, the message contains:
(1) providing assistance information of cell selection for the first network node, which at least includes one of:
(Step 1-b-1)
node configuration information
   identification information of a second serving node
   identification information of a second serving cell
(Step 1-a-2)
   identification information of a first serving node
   information of a selectable serving node
   identification information of a first serving cell
   information of a selectable cell
(2) providing request information or response information for configuration update for the first network node, wherein the request information refers to the configuration update requested by the second network node, and the response information is a response to the request of the first network node, and the information at least includes one of:
(Steps 3-2/3-3/3-4/3-5)
   information of accepted data
   information of rejected data
   information of data to be configured
(Step 2-2)
   information of data accepted to be newly created
   information of data rejected to be newly created
   second interface information
   response information of a migration method

The above step 2 may be triggered by step 1, or a response to step 1, or steps 1 and 2 are performed separately.

The details of the information contained in the above first message and second message can be referred to the description of the following four aspects, and the following four aspects describe the different implementations of the above steps 1 and 2 in different scenarios respectively.

### A First Aspect: Selection of a Target Serving Cell of the First Node

The procedure is mainly used to select a new target serving cell (PCell or PSCell) for the first node, and the new target serving cell and the current serving cell of the first node may belong to the same base station or different base stations. The scenario referenced by the procedure may be any one of the above scenarios 1/2/3/4/5/6. In these scenarios, the current serving cell of the first node is a cell managed by the third node. According to the prior art, the third node should decide the new serving cell of the first node, but this may lead to the problem that if the target serving cell selected by the third node belongs to a serving cell of the fourth node, it is unknown whether the fourth node serves the data transport between the first node and the second node (for example, if there is no interface between the second node and the fourth node, the configuration between the second node and the fourth node cannot be performed), which leads to the problem that the selected target cell is not suitable.

Before introducing the solution, the invention defines a “service area”: the service area will contain one or more nodes (if an interface is established between the first node and the second node, the nodes in the service area can interact with the second node to complete data transport on the interface, and these data transports are completed through the network managed by the nodes in the area), or one or more cells (if an interface is established between the first node and the second node, the nodes serving these cells may complete the data transport with the second node on the interface, and these data transports are completed through the network managed by the serving nodes of the cells in the area). In an embodiment, the service area is associated with a node, such as the second node, and all the nodes in the service area (or nodes serving the cells in the area) may interact with the second node (or have interfaces with the second node, such as Xn/X2 interfaces) to complete data transport between the first node and the second node, so the nodes (or cells) contained in the service areas associated with different nodes may be different; in an embodiment, the service area is associated with a cell; in another embodiment, the service area is not associated with a node, and any two nodes (or serving nodes of any two cells) in the service area may interact with each other to configure the data transport of the first node. In an embodiment, the service area is not associated with a cell, and the nodes serving any two cells in the service area may interact with each other to configure the data transport of the first node. Specifically, as an example, the service area may be named as a partial migration service area, and an inter-topology data transport service area, that is, the nodes in the service area (or serving nodes of the cells in the service area) may configure the relay node that performs partial migration, or configure the relay node for inter-topology data transport.

In order to solve the problem that the selection of the target serving cell is not suitable, the invention proposes the following possible methods.

### 1) Method 1: Decision is Made by the Second Node

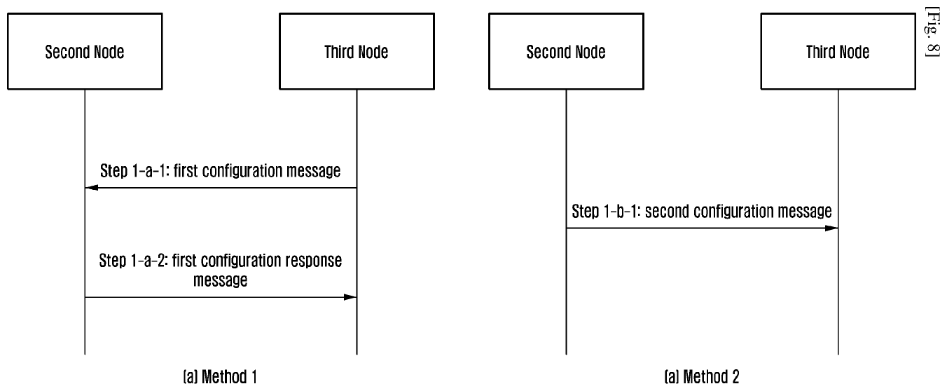

In this method, the third node will provide an alternative serving cell or an alternative fourth node for the second node, and then the second node determines the target serving cell or the fourth node and notify the third node. Specifically, the implementation includes the following steps, as shown in FIG. 8(a):

Step 1-a-1: the third node transmits a first configuration message to the second node, wherein the message is used to notify information related to the serving cell of the first node, and the message at least includes one of:
identification information of a target node, which indicates a node selected by the third node to serve the first node
information of candidate serving nodes, which provides identification information of one or more nodes selected by the third node that can serve the first node
identification information of a target cell, which indicates a cell selected by the third node to serve the first node. The cell may be a PCell or a PSCell, and the identification information may be PCI and/or frequency information, NCGI, ECGI, or other information that may identify a cell
information of candidate cells, which provides identification information of one or more cells selected by the third node that can serve the first node. These cells may be candidate cells as PCells or PSCells, and the information at least includes one of:
identification information of a cell, such as PCI and/or frequency information, NCGI, ECGI, and other information that may identify a cell
measurement result information of a cell, such as RSRP information, RSRQ information, etc.
information of cell load
identification information of a base station where the cell is located

Step 1-a-2: the second node transmits a first configuration response message to the third node, for confirming the target node or cell selected by the third node (e.g., the node or cell identified by the identification information of the target node or the identification information of the target cell in step 1-a-1), and/or the message is used to notify the node or cell selected by the second node to serve the first node, and the message at least includes one of:
identification information of a first serving node, which identifies a node selected by the second node that can serve the first node. In an embodiment, the information is selected according to the “information of a candidate serving node” in step 1-a-1
information of a selectable serving node, which indicates identification information of one or more nodes selected by the second node that can serve the first node. In an embodiment, the information is selected according to the “information of candidate serving nodes” in step 1-a-1
identification information of a first serving cell, or the identification information of the above target node, which identifies the identification information of the cell selected by the second node that can serve the first node. In an embodiment, the information is selected according to “information of candidate cells” in step 1-a-1
information of a selectable cell, or the above identification information of a target cell, which indicates identification information of one or more cells selected by the second node that can serve the first node. In an embodiment, the information is selected according to the “information of a candidate cell” in step 1-a-1

In the above method, if the second node cannot determine a suitable target cell according to the information received in step 1-a-1, that is, the target cell selected by the second node will result in data between the first node and the second node cannot be transported by the cell selected by the third node, it is necessary to migrate the F1 interface of the first node. For details, please refer to the fourth aspect of the invention.

The technical effect of the above method is that the third node can obtain the information of the suitable target cell through negotiation with the second node, thereby configuring the suitable serving cell for the first node, enabling the serving node of the serving cell to interact with the second node to configure the inter-network (topology) data transport of the first node, avoiding that the serving node of the selected serving cell cannot configure the inter-network (topology) data transport of the first node, and reducing the interruption of data transport.

The above first configuration message and first configuration response message may be messages of the existing Xn/X2 interface respectively or newly defined messages.

### 2) Method 2: the Decision is Made be the Third Node

In this method, the selection of the serving cell of the first node is completely determined by the third node. However, in order to select a suitable serving cell, the third node will refer to some assistance information from the second node, and the implementation includes the following steps, as shown in FIG. 8(b):

Step 1-b-1: the second node transmits a second configuration message to the third node. In an embodiment, the second node is a node that has F1 interface with the first node, and the third node is a node where the RRC connection of the first node is located. In another embodiment, the second node and the third node are any two nodes. The message is used to provide configuration information related to serving the relay node (such as the first node) to the third node, and the message at least includes one of:
node configuration information. In an embodiment, the configuration information is configuration information of the second node. In another embodiment, if the above “second configuration message” is transmitted by other nodes, the information is configuration information of the transmitting node, and the information at least includes the following information:
   identification information of a node
   identification information of service area to which the node belongs
   identification information of service area associated with the node
   identification information of nodes contained in service area associated with the node
   identification information of cells contained in service area associated with the node
   information of a served cell, which at least includes one of:
      identification information of the cell
      identification information of the belonged service area
      identification information of service area associated with the cell
      identification information of nodes included in service area associated with the cell
      identification information of cells contained in service area associated with the cell
identification information of a second serving node, which indicates identification information of one or more other nodes that can serve the first node. In an embodiment, the node identified by the information is a node that has an interface with the second node. In another embodiment, the node identified by the information is a node that can interact configuration information with the second node to serve the first node. In another embodiment, the node identified by the information is a node that can support inter-topology data transport of the first node together with the second node
identification information of a second serving cell, which indicates identification information of one or more cells that can serve the first node. In an embodiment, the serving node of the cell identified by the information is a node that has an interface with the second node. In another embodiment, the serving node of the cell identified by the information is a node that can interact configuration information with the second node to serve the first node. In another embodiment, the serving node of the cell identified by the information is a node that can support inter-topology data transport of the first node together with the second node

Furthermore, the above step 1-b-1 is illustrated by taking the interaction between the second node and the third node as an example. In an actual system, the step may be performed between any two nodes, and the information contained in the above second configuration message is the information of the transmitting node side.

According to the information in step 1-b-1, the third node may decide the cell serving the first node, thereby configuring the serving cell for the first node.

In the above method, if the third node cannot determine a suitable target cell, the cell selected by the third node will result in data between the first node and the second node cannot be transported by the cell selected by the third node. At this time, it is necessary to migrate the F1 interface of the first node. For details, please refer to the fourth aspect of the invention.

The technical effect of the above method is that the third node can select an appropriate target cell according to the assistance information provided by the second node, so that the serving node of the target cell can interact with the second node to configure the inter-network (topology) data transport of the first node, which avoids that the serving node of the selected target cell cannot configure the inter-network (topology) data transport of the first node and reduces the interruption of data transport.

The above second configuration message may be a message of the existing Xn/X2interface, such as Xn/X2 Setup Request, Xn/X2 Setup Response, Configuration update, configuration update acknowledge, or a newly defined message, such as intertopology transport modification request/required message, inter-topology transport modification acknowledge/confirm message, etc.

### A Second Aspect: Configuration of the Target Serving Cell of the First Node

After the third node selects the target serving cell of the first node, the third node may configure the cell for the first node according to the following processes:
process 1: a handover or migration process of the first node, one of the purposes of which is to change the PCell serving the first node.

In an implementation, the process may occur in the topology managed by the third node (such as scenario 1), and the involved process is a handover process inside the central unit, which will not be repeated here. In another implementation, the process may occur between the third node and the fourth node (such as scenario 2, that is, the PCell of the first node is changed from a cell managed by the third node to a cell managed by the fourth node), and the process involved is a handover/migration process between central units.
process 2: a process of addition of a PSCell of the first node, one of the purposes of which is to configure a PSCell for the first node.

In an implementation, the process may occur in the topology managed by the third node (such as scenario 3), and the involved process is the PSCell addition process inside the central unit, which will not be repeated here. In another implementation, the process may occur between the third node and the fourth node (such as scenario 4, a cell managed by the fourth node is added for the first node), and the involved process is a PSCell addition process between central units.
process 3: a process of changing of the PSCell of the first node, one of the purposes of which is to change the PSCell serving the first node.

In an implementation, the process may occur in the topology managed by the third node (such as scenario 5), and the involved process is the PSCell change process inside the central unit, which will not be repeated here. In another implementation, the process may occur between the third node and the fourth node (such as scenario 6, that is, the PSCell of the first node is changed to a cell managed by the fourth node), and the involved process is the PSCell change process between central units.

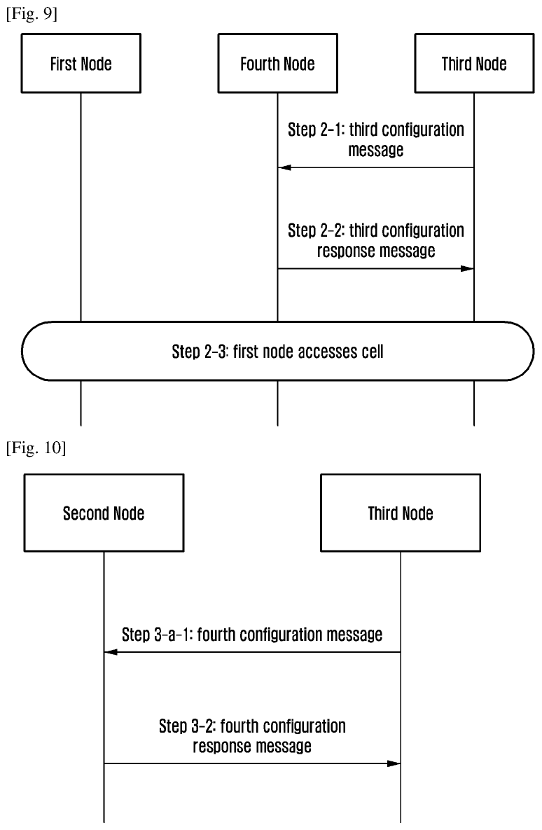

Before the above process is performed, the connection state of the first node is: an RRC connection is established between the mobile terminal part of the first node and the third node, and F1 interface is established between the distributed unit part of the first node and the second node. In these above processes, the serving node of the target serving cell may not know that the first node and the second node are still connected, so that the data transport between the first node and the second node cannot be configured. To solve this problem, the invention proposes the following processes, as shown in FIG. 9:

Step 2-1: the third node transmits a third configuration message to the fourth node, which is used to provide the fourth node with information required to configure the first node. The content of the message may be referred to a handover request message or a secondary node addition request message. In addition, in order to configure the data transport between the first node and the second node, at least one of the following information may also be included:
data information of a first node, which indicates information of the data belonging to the first node that needs to be served by the fourth node. For the content contained in the information, the above “data configuration information” may be referred to. In an embodiment, after receiving the information, the fourth node will provide configuration information related to the data to the second node
information of data to be newly created, the data to be newly created is newly added data that needs to be configured by the fourth node. The above “data configuration information” may be referred to for the content contained in the information. In an embodiment, the information may be considered as being generated by the third node that has no interface (such as F1 interface) with the first node. In another embodiment, the information may be considered as being generated by the second node that has an interface (such as F1 interface) with the first node and then forwarded by the third node
first interface information, which can help the fourth node identify whether the information contained in its interface signaling (such as the signaling received from the third node or the signaling received from other nodes (such as the second node) is for the first node. If the signaling contains the identification information, it indicates that the information related to the identification information in the signaling is for the first node. The information at least includes one of:
   first information of a non-fourth node interface, wherein the interface targeted by the information is not the interface of the fourth node (such as the interface between the second node and the third node), and the information at least includes one of:
      first interface node identification information, which is identification information of the first node on the non-fourth node interface (such as the interface between the second node and the third node, also referred to as an unrelated interface), such as XnAP ID
      first identification information of a node where the interface is located, such as the identification information of the second node and the identification information of the third node
   first information of fourth node interface, wherein the interface targeted by the information is the interface of the fourth node, such as the interface between the fourth node and the third node, or the interface between the fourth node and the second node, and the information at least includes one of:
      second interface node identification information, which is identification information of the first node on the interface of the fourth node (the interface between the fourth node and the third node, or the interface between the fourth node and the second node, also referred to as a related interface), such as XnAP ID
      second identification information of a node where the interface is located, such as the identification information of the second node, the identification information of the third node, or the identification information of the fourth node.
   first identification information, which is identification information of the first node used when interacting the data transport configuration of the first node between the second node and the fourth node, and will be contained in the signaling interacted between the second node and the fourth node. The identification information may be allocated and transmitted to the third node by the second node, or may be allocated by the third node. In an embodiment, the information may be the existing identification information. In another embodiment, the information is newly defined information.
first information of a connected node, which indicates information of a node that has an interface (such as F1 interface) with the first node, and the information at least includes one of:
   identification information of a node, such as the identification information of the second node
   address information, such as address information of the second node side, e.g., an IP address
service area indication information, wherein for the description of the service area, the above “first aspect” may be referred to. The indication information may be service area identification information. In an embodiment, the service area may be the service area where the second node is located. In another embodiment, the service area may be the service area to which the cell where the first node is currently located (such as the serving cell under the third node) belongs. According to the information, the fourth node may determine whether it can interact the data transport configuration information of the first node with the second node
request information for a migration method, which is used to inform the fourth node of the migration method with regard to the first node requested by the third node, and the migration method that may be indicated by the request information is partial migration or full migration

Step 2-2: the fourth node transmits a third configuration response message to the third node, which is used to provide the third node with configuration information required to serve the first node. For the content of the message, the content in the handover response message or the secondary node addition response message may be referred to. In addition, in order to configure the data transport between the first node and the second node, at least one of the following information may be included:
information of data accepted to be newly created, wherein for the content contained in the information, the above “data configuration information” may be referred to. In an embodiment, the information may be considered as being generated by the third node that has no interface (such as F1 interface) with the first node
information of data rejected to be newly created, wherein for the content contained in the information, the above “data configuration information” may be referred to
second interface information, which can help the second node identify whether the information contained in its interface signaling (such as the signaling received from the third node or the signaling received from other nodes (such as the fourth node) is for the first node. If the signaling contains the identification information, it indicates that the information related to the identification information in the signaling is for the first node. The information at least includes one of:
   first information of a non-third node interface, wherein the interface targeted by the information is not the interface of the third node (such as the interface between the second node and the fourth node), and the information at least includes one of:
      third interface node identification information, which is identification information of the first node on the non-third node interface (also referred to as an unrelated interface, such as the interface between the second node and the fourth node), such as XnAP ID
      third identification information of a node where the interface is located, such as the identification information of the second node, the identification information of the fourth node
   first information of third node interface, wherein the interface targeted by the information is the interface of the third node (also referred to as a related interface), such as the interface between the third node and the fourth node, or the interface between the third node and the second node, and the information at least includes one of:
      fourth interface node identification information, which is identification information of the first node on the interface of the third node (also referred to as a related interface, such as the interface between the fourth node and the third node, or the interface between the third node and the second node), such as XnAP ID.
      fourth identification information of a node where the interface is located, such as the identification information of the second node, the identification information of the third node, or the identification information of the fourth node
   second identification information, which is identification information of the first node used when interacting the data transport configuration of the first node between the second node and the fourth node, and will be contained in the signaling interacted between the second node and the fourth node. The identification information may be allocated and transmitted to the third node by the fourth node. In an embodiment, the information may be the existing identification information. In another embodiment, the information is newly defined information
response information of a migration method. In an embodiment, the information indicates whether the fourth node accepts the migration method requested in step 2-1. In another embodiment, the information may indicate the migration method selected by the fourth node (such as partial migration or full migration). The response information is determined by the fourth node based on one or more information in step 2-1 (such as “first information of a connected node”, “node identification information of interface” and “service area indication information”). If the requested partial migration is accepted, it indicates that the fourth node may configure the data transport of the first node with the second node, so as to perform the data transport between the first node and the second node in the network managed by the fourth node. If the requested partial migration cannot be accepted, the F1 interface of the first node needs to be migrated from the second node to other nodes. The method of migrating the F1 interface may be referred to the fourth aspect of the invention.

If it is determined by the third configuration response message that the fourth node may interact with the second node and transport the data between the first node and the second node in the network served by the fourth node, it indicates that the above target serving cell selected by the third node (the serving cell of the fourth node) is a suitable cell that can keep the data between the first node and the second node for intertopology transport; if it is determined by the third configuration response message that the fourth node cannot interact with the second node, and thus transporting of the data between the first node and the second node cannot be realized in the network served by the fourth node, it indicates that the above target serving cell selected by the third node (the serving cell of the fourth node) is not a suitable cell that can keep the data between the first node and the second node for inter-topology transport. Therefore, in addition to completing the configuration of the target serving cell of the first node, in an implementation, the above process may also determine whether the interface (such as F1 interface) of the first node needs to be migrated when the method of the second aspect of the invention is not used.

Step 2-3: the first node (or the mobile terminal part of the first node) accesses a newly configured cell. In this step, it may include: 1) the third node transmits a user configuration request message to the first node, which is used to configure the first node to access the new cell, and an RRC reconfiguration message may be referred to for the message, 2) the first node performs a random access process in the newly configured cell to communicate with the network through the newly configured cell, 3) the first node transmits a configuration complete message to the third node or the fourth node. The handover process or PSCell addition or PSCell change process in the prior art may be referred to for this process.

The technical effect of the above steps is to configure a new serving cell for the first node, and provide the information of the nodes to which the first node is connected (such as the nodes that establish interfaces with the first node) at the same time, so as to ensure that the new serving node of the first node can still configure the internetwork (topology) data transport of the first node and avoid the interruption of data transport.

The above third configuration message and third configuration response message may be Handover Request and Handover Request Acknowledge messages of the existing Xn/X2 interface, respectively, or second node addition/modification request and second node addition/modification request acknowledge messages, etc., or new messages, such as inter-topology transport modification request/required message, inter-topology transport modification acknowledge/confirm message, etc.

A third aspect: configuration update procedure of first node.

After configuring a new serving cell (such as PCell, PSCell) for the first node, if the first node still keeps the connection with the second node (such as F1 connection), it is necessary to update the configuration of the second node. However, the serving node of the cell to which the first node is connected may be a new node (such as the fourth node), which is unknown to the second node. Therefore, the addition of a new serving cell will cause that the configuration of the data transport between the first node and the second node cannot be performed. To solve this problem, the invention proposes the following implementation methods:

### 1) Method 1: Configuration Update Procedure Initiated by Third Node

In this method, the configuration update procedure may occur after the first node accesses the new serving cell, or during the first node accessing the new serving cell, or after the third node determines the new serving cell. The procedure includes the following steps, as shown in FIG. 10:

Step 3-a-1: the third node transmits a fourth configuration message to the second node, which at least includes one of:
first indication information of configuration change, which is used to notify the second node that the configuration with regard to the first node is changed. After receiving the information, the second node may know that the configuration of the first node needs to be changed, so as to carry out the subsequent procedure to obtain the updated configuration. The information at least includes one of:
   indication information of node change, which is used to indicate that the node to which the first node is connected (the node may be the node where the PCell accessed by the first node is located, or the node where the PSCell accessed by the first node is located, etc.) is changed. In an embodiment, the node may be a distributed unit of a (directly or indirectly) connected base station (for example, when the third node is a base station, the distributed unit is the distributed unit of the third node, and when the third node is a central unit or a control plane part of a central unit of a base station, the distributed unit is a distributed unit to which the third node is connected). In another embodiment, the node may be a (directly or indirectly) connected base station or a central unit of a base station or a control plane part of a central unit of a base station. In another embodiment, the node may be a parent node to which the first node is connected
   indication information of transport reconfiguration, which is used to indicate that the configuration of transport of all or part of data between the second node and the first node needs to be reconfigured
   request indication information of transport reconfiguration, which is used to request the second node to reconfigure the configuration of transport of all or part of data between it and the first node
   indication information of data for transport reconfiguration, which is used to inform the second node which data transport between the second node and the first node needs to be reconfigured, and at least includes one of:
      indication information of data flow, such as traffic ID, which indicates the identification information of the data flow to which the data that needs to be reconfigured belongs
      indication information of a tunnel, such as an ID of the tunnel, information of the tunnel (such as transport layer address information, identification information of a tunnel endpoint (Tunnel Endpoint ID), which indicates the information of the tunnel used by the data that needs to be reconfigured
      indication information of transport network layer (TNL) association, such as associated ID, associated information (port information, address information)
      identification information of a bearer, which indicates the identification information of the bearer to which the data that needs to be reconfigured belongs
      address information of a transport layer, which indicates the address information used by the data that needs to be reconfigured
      identification information of transport routing, which indicates the routing ID used by the data that needs to be reconfigured
      address information of an adaptation layer, which indicates the address information of the adaptation layer used by the data that needs to be reconfigured, such as BAP (Backhaul adaptation protocol) address information
first configuration update information, which is used to provide new configuration information used in data transport between the second node and the first node, and may be updated configuration information. According to the information, the second node may know that the configuration of the first node needs to be changed, so as to carry out the subsequent procedure to obtain the updated configuration. The reason for this configuration update may be that the third node changes the cell for the first node, or the third node adds a PSCell for the first node, or the third node changes the PSCell to which the first node is connected, and so on. The information at least includes one of:
   address information of a distributed unit of a base station, such as IP address, BAP address, etc. The information indicates the address information of the distributed unit of the base station to which the first node is connected. In an embodiment, the distributed unit is a distributed unit to which the PCell accessed by the first node is connected. In another embodiment, the distributed unit is a distributed unit to which the PSCell accessed by the first node is connected. Further, according to the information, the second node knows that the distributed unit to which the first node is connected is changed or added, thereby implicitly knowing whether to reconfigure its data transport with the first node
   address information of a parent node, such as BAP address, which indicates the address information of the parent node to which the first node is connected. In an embodiment, the parent node is a parent node where the PCell accessed by the first node is located. In another embodiment, the parent node is a parent node where the PSCell accessed by the first node is located. Further, according to the information, the second node knows that the parent node to which the first node is connected is changed or added, thereby implicitly knowing whether to reconfigure its data transport with the first node
first access information, which is used to provide information related to the access of the first node (such as the accessed cell, the accessed base station, etc.). The second node may decide to perform configuration interaction with regard to the data transport of the first node with which base station or donor node after receiving the information. The information at least includes one of:
   identification information of a cell, which indicates a cell accessed by the first node or a cell serving the first node. In an embodiment, the cell is a primary cell (such as PCell). In another embodiment, the cell is a primary secondary cell (such as PSCell). The identification information may include at least one of PCI, frequency information, NCI and NR CGI. A possible function of the information is to help the second node to determine the cell accessed by the first node, thereby determining a base station accessed by it, and then interacting with the base station to configure the data transport of the first node
   identification information of a serving node, which indicates identification information of the base station accessed by the first node. In an embodiment, the base station may be a base station with a donor node function. In another embodiment, the base station may also be a base station without a donor node function; in another embodiment, the base station may be a base station different from the second node and/or the third node, such as the fourth node in the above scenario 2/4/6. A possible function of the information is to help the second node to determine the cell accessed by the first node, thereby determining a base station accessed by it, and then interacting with the base station to configure the data transport of the first node
first configuration information of node, which indicates identification information of the first node. A possible function of the identification information is that the second node may utilize the identification information to interact with other nodes (such as the fourth node) serving the first node, so as to help other nodes identify whether information in its received message is for the first node. For example, when the message transmitted by the second node to the fourth node contains the information, the fourth node may know that information in the message corresponding to the information is for the first node. The information at least includes one of:
   first information of a non-second node interface, wherein the interface targeted by the information is not the interface of the second node (such as the interface between the third node and the fourth node), and the information at least includes one of:
      fifth interface node identification information, which is identification information of the first node on the non-second node interface (also referred to as an unrelated interface, such as the interface between the third node and the fourth node), such as XnAP ID
      fifth identification information of a node where the interface is located, such as the identification information of the third node and the identification information of the fourth node
   first information of second node interface, wherein the interface targeted by the information is the interface of the second node, also referred to as a related interface, such as the interface between the second node and the third node, or the interface between the second node and the fourth node, and the information at least includes one of:
      sixth interface node identification information, which is identification information of the first node on the interface of the second node (the interface between the second node and the third node, or the interface between the second node and the fourth node), such as XnAP ID
      sixth identification information of a node where the interface is located, such as the identification information of the second node, the identification information of the third node, or the identification information of the fourth node
   second identification information, which is identification information of the first node used when interacting the data transport configuration of the first node between the second node and the fourth node, and will be contained in the signaling interacted between the second node and the fourth node. The identification information may be allocated by the fourth node, the third node, or the second node. In an embodiment, the information may be the existing identification information. In another embodiment, the information is newly defined information
   user identification information of a cell, such as C-RNTI, which may be identification information of the first node within the serving cell of the fourth node, and may further contain the identification information of the cell, such as the identification information of the cell (PCell or PSCell) belonging to the fourth node that serves the first node
first data configuration update request information, which is used to inform the second node of data of which the configuration is requested to update, and at least includes one of:
   information of data to be modified, wherein for the content contained in the information, the above “data configuration information” may be referred to. In an embodiment, the information is generated according to information transmitted by the fourth node to the third node, such as the “information of data accepted to be newly created” contained in the above step 2-2. Furthermore, the content contained in the information may be considered as being generated by a node that has no interface with the first node
   information of data to be released, wherein for the content contained in the information, the above “data configuration information” may be referred to. In an embodiment, the information is generated according to information transmitted by the fourth node to the third node, such as the “information of data rejected to be newly created” contained in the above step 2-2
first group update indication information, which indicates the configuration that needs to be updated, and is used to update all data with the same configuration information, such as to perform group update. The information at least includes one of:
   adaptation layer address (such as BAP address) update information, which indicates the adaptation layer address that needs to be updated, such as new adaptation layer address, old adaptation layer address
   transport layer address (such as IP address) update information, which indicates the transport layer address that needs to be updated, such as new transport layer address, old transport layer address
   ingress backhaul channel update information, which indicates the ingress backhaul channel that needs to be updated, such as new ingress backhaul channel, old ingress backhaul channel
   egress backhaul channel update information, which indicates the egress backhaul channel that needs to be updated, such as new egress backhaul channel, old egress backhaul channel
   ingress routing identification update information, which indicates the ingress routing identification that needs to be updated, such as new ingress routing identification, old ingress routing identification
   egress routing identification update information, which indicates the egress routing identification that needs to be updated, such as new egress routing identification, old egress routing identification
   header indication update information, which indicates the header indication that needs to be updated, such as the new DSCP value, the old DSCP value, the new flow label value, the old flow label value
first data transport configuration information, which is used to help the second node configure the data transport of the first node. In an embodiment, the configuration information is generated by the third node. In another embodiment, the configuration information is generated and transmitted to the third node by other nodes (such as the fourth node), and then transmitted by the third node to the second node. The information at least includes one of:
   header information, which indicates information that needs to be added in the header, such as a DSCP value, a flow label value, etc. In an embodiment, the indication information is applied to all packets transmitted to the first node (such as packets of F1 interface), such as a default DSCP/Flow Label value
   IP address information, which indicates the IP address of the first node when the second node perform data transport (such as F1 interface data transport) with the first node. Further, it may also indicate the data type to which the IP address applies (such as F1 interface data, non-F1 interface data, F1 interface user plane (F1-U) data, F1 interface control plane (F1-C) data, UE-associated F1-C data, non-UE-associated F1-C data), BAP address information associated with the IP address (for example, the BAP address is an address of the distributed unit of the donor node associated with the IP address), etc.

The technical effect of the above method is to provide the updated configuration for the second node, and inform the second node of the new serving node to which the first node is connected, which can help the second node determine the configuration that needs to be updated, as well as the node with which the second node continues performing the inter-network (topology) data transport of the relay node, and can keep the continuity of data transport and avoide transport interruption.

The above fourth configuration message may be a message of the existing Xn/X2 interface, such as secondary node modification required message, etc., or a message of a new Xn/X2 interface, such as inter-topology transport modification request/required message, inter-topology transport modification acknowledge/confirm message, etc.

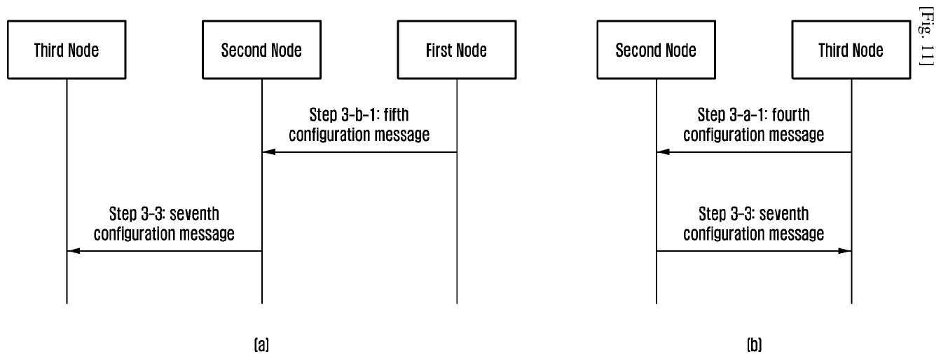

### Method 2: Configuration Update Procedure Initiated by the First Node, as Shown in FIG. 11(a)

Step 3-b-1: the first node transmits a fifth configuration message to the second node, which is used to notify the second node of new configuration information, and at least includes one of:
second indication information of configuration change, the description in the above step 3-a-1 may be referred to for the information
second configuration update information, the description in the above step 3-a-1 may be referred to for the information
second access information, the description in the above step 3-a-1 may be referred to for the information
second configuration information of node, which indicates identification information of the first node. A possible function of the identification information is that the second node may utilize the identification information to interact with other nodes (such as the fourth node) serving the first node, so as to help other nodes identify whether information in its received message is for the first node. For example, when the message transmitted by the second node to the fourth node contains the information, the fourth node may know that information in the message corresponding to the information is for the first node. The information at least includes one of:
   third identification information, which is identification information of the first node used when interacting the data transport configuration of the first node between the second node and the fourth node, and will be contained in the signaling interacted between the second node and the fourth node. The identification information may be allocated by the fourth node, the third node, or the second node. In an embodiment, the information may be existing identification information. In another embodiment, the information is newly defined information. Further, the third identification information may be transmitted by the second node/third node/fourth node to the first node
   user identification information of a cell, such as C-RNTI
   identification information of a serving cell, wherein the serving cell is a cell serving the first node, and may be a PCell or a PSCell
second data transport configuration information, the description in the above step 3-a-1 may be referred to for the information

The technical effect of the above method is that the second node can obtain the information of the new cell to which the first node is connected, thereby helping the second node determine to configure the inter-network (topology) data transport of the relay node together with it, which can keep the continuity of data transport and avoid transport interruption.

The above fifth configuration message may be a message of the existing F1 interface, such as a gNB-DU configuration update message, or a message of a new F1 interface.

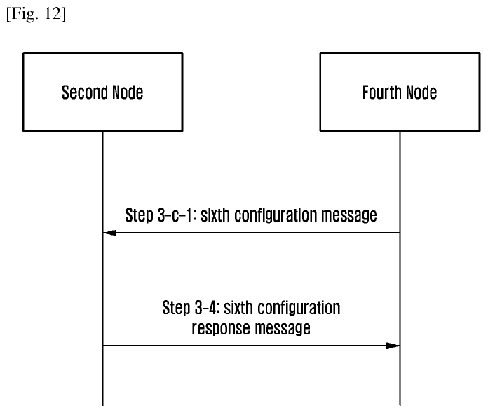

### Method 3: Configuration Update Procedure Initiated by the Fourth Node, as Shown in FIG. 12

Step 3-c-1: the fourth node transmits a sixth configuration message to the second node, which is used to inform the second node of new configuration information, and at least includes one of:
third indication information of configuration change, the description in the above step 3-a-1 may be referred to for the information
third configuration update information, the description in the above step 3-a-1 may be referred to for the information
third access information, the description in the above step 3-a-1 may be referred to for the information
third configuration information of node, which indicates identification information of the first node. A possible function of the identification information is that the second node may utilize the identification information to interact with other nodes (such as the fourth node) serving the first node, so as to help other nodes identify whether information in its received message is for the first node. For example, when the message transmitted by the second node to the fourth node contains the information, the fourth node may know that information in the message corresponding to the information is for the first node. The information at least includes one of:
   second information of a non-second node interface, wherein the interface targeted by the information is not the interface of the second node (also referred to as an unrelated interface, such as the interface between the third node and the fourth node), and the information at least includes one of:
      seventh interface node identification information, which is identification information of the first node on the non-second node interface (also referred to as an unrelated interface, such as the interface between the third node and the fourth node), such as XnAP ID
      seventh identification information of a node where the interface is located, such as the identification information of the third node and the identification information of the fourth node
   second information of second node interface, wherein the interface targeted by the information is the interface of the second node, also referred to as a related interface, such as the interface between the second node and the third node, or the interface between the second node and the fourth node, and the information at least includes one of:
      eighth interface node identification information, which is identification information of the first node on the interface of the second node (also referred to as a related interface, the interface between the second node and the third node, or the interface between the second node and the fourth node), such as XnAP ID
      eighth identification information of a node where the interface is located, such as the identification information of the second node, the identification information of the third node, or the identification information of the fourth node
   fourth identification information, which is identification information of the first node used when interacting the data transport configuration of the first node between the second node and the fourth node, and will be contained in the signaling interacted between the second node and the fourth node. The identification information may be allocated by the fourth node, the third node, or the second node. In an embodiment, the information may be existing identification information. In another embodiment, the information is newly defined information
   user identification information of a cell, such as C-RNTI, which may be identification information of the first node within the serving cell of the fourth node, and may further contain the identification information of the cell, such as the identification information of the cell (PCell or PSCell) belonging to the fourth node that serves the first node
third data configuration update request information, the description in the above step 3-a-1 may be referred to for the information
third group update indication information, the description in the above step 3-a-1 may be referred to for the information
third data transport configuration information, the description in the above step 3-a-1 may be referred to for the information

The technical effect of the above method is that the fourth node will establish the connection with the second node, thereby helping the second node determine to configure the inter-network (topology) data transport of the relay node together with it, which can keep the continuity of data transport and avoid transport interruption.

The above sixth configuration message may be a message of the existing Xn/X2interface, such as secondary node modification required message, etc., or a message of a new Xn/X2 interface, such as inter-topology transport modification request/required message, inter-topology transport modification acknowledge/confirm message, etc.

When the second node knows that the configuration of the first node needs to be updated by any of the above three methods, the following steps may also be included:

Optionally, step 3-2: the second node transmits a fourth configuration response message to the third node. In an embodiment, this step may occur after step 3-a-1, as shown in FIG. 10.

Optionally, step 3-3: the second node transmits a seventh configuration message to the third node. In an embodiment, this step may occur after step 3-b-1, as shown in FIG. 11(a). In another embodiment, this step may occur after step 3-a-1, as shown in FIG. 11(b).

Optionally, step 3-4: the second node transmits a sixth configuration response message to the fourth node. In an embodiment, this step may occur after step 3-c-1, as shown in FIG. 12.

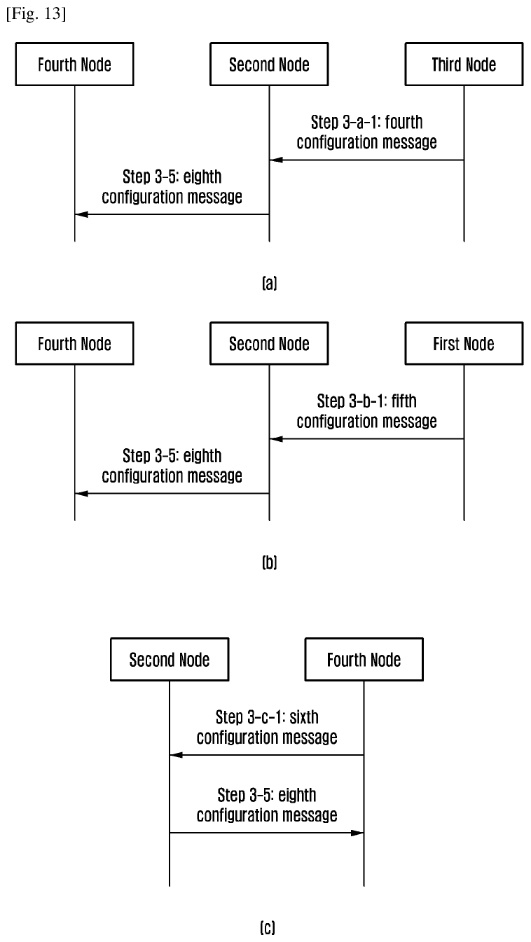

Optionally, step 3-5: the second node transmits a eighth configuration message to the fourth node. In an embodiment, this step may occur after step 3-a-1, as shown in FIG. 13(a). In an embodiment, this step may occur after step 3-b-1, as shown in FIG. 13(b). In an embodiment, this step may occur after step 3-c-1, as shown in FIG. 13(c).

The above “fourth configuration response message”, “seventh configuration message”, “sixth configuration response message” and “eighth configuration message” may at least contain one of:
information of accepted data. In an embodiment, the information is determined according to the information received in step 3-a-1 or step 3-c-1, and at least includes one of:
   information of data accepted to be modified, wherein for the content contained in the information, the above “data configuration information” may be referred to
   information of data accepted to be released, wherein for the content contained in the information, the above “data configuration information” may be referred to
information of rejected data. In an embodiment, the information is determined according to the information received in step 3-a-1 or step 3-c-1 (such as “first data configuration update request information”), and at least includes one of:
   information of data rejected to be modified, wherein for the content contained in the information, the above “data configuration information” may be referred to
   information of data rejected to be released, wherein for the content contained in the information, the above “data configuration information” may be referred to
first information of data to be configured. In an embodiment, the information is determined according to the information received in step 3-a-1 or step 3-b-1 or step 3-c-1 (such as “indication information of data for transport reconfiguration”), and at least includes one of:
   information of data to be newly created, wherein for the content contained in the information, the above “data configuration information” may be referred to
   information of data to be modified, wherein for the content contained in the information, the above “data configuration information” may be referred to
   information of data to be released, wherein for the content contained in the information, the above “data configuration information” may be referred to

The technical effect that can be achieved through the above process is that, after the serving cell of the relay node is changed, the second node can obtain the updated configuration information or request updating the configuration, so as to keep the internetwork (topology) transport of the relay node and reduce data interruption.

The above “fourth configuration response message”, “seventh configuration message”, “sixth configuration response message” and “eighth configuration message” may be messages of the existing Xn/X2 interface, such as secondary node modification request/required message, secondary node modification acknowledge/confirm message, etc., or newly defined messages, such as inter-topology transport modification request/required message, inter-topology transport modification acknowledge/confirm message, etc.

### A Fourth Aspect: Context Migration Procedure

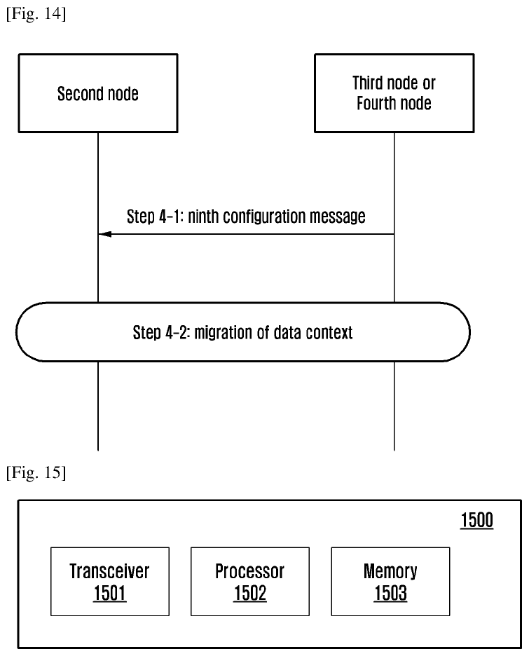

In order to ensure data transport on the first node, the third node may need to acquire the context of all data on the first node. In an embodiment, this occurs because the second node cannot interact with the node where the serving cell of the first node is located. In another embodiment, this occurs because the second node determines that such migration of context may help the data transport of the first node. At this time, the following steps may also be included, as shown in FIG. 14:

Step 4-1: the third node or the fourth node transmits a ninth configuration message to the second node, which is used to request the second node to migrate the context information, and at least includes one of:
indication information for requesting migration, which indicates that the second node needs to migrate the context of the served data on the first node to other nodes (such as the third node, the fourth node, or other nodes different from the third node and the fourth node)
identification information of a target node, which indicates a target node to which the context needs to be migrated
information of data to be migrated, which indicates data of which the context needs to be migrated, and at least includes one of:
   indication information of data flow, such as traffic ID, which indicates the identification information of the data flow to which the data that needs to be reconfigured belongs
   indication information of a tunnel, such as an ID of the tunnel, information of the tunnel (such as transport layer address information, identification information of a tunnel endpoint (Tunnel Endpoint ID), which indicates the information of the tunnel used by the data that needs to be reconfigured
   identification information of a bearer, which indicates the identification information of the bearer to which the data that needs to be reconfigured belongs
   address information of a transport layer, which indicates the address information used by the data that needs to be reconfigured
   identification information of transport routing, which indicates the routing ID used by the data that needs to be reconfigured
   address information of an adaptation layer, which indicates the address information of the adaptation layer used by the data that needs to be reconfigured, such as BAP (Backhaul adaptation protocol) address information

Step 4-2: the second node migrates the data context to the third node or other nodes (such as the fourth node), wherein the migrated information includes the data information of the user accessing the first node, such as bearer information (the identification information of the bearer and QoS information of the bearer), PDU session information (such as identification information of the PDU session, QoS information of the PDU session, etc.).

The technical effect of the above steps is to help the second node determine whether to migrate the interface of the relay node to other nodes, so that other nodes continue to configure the inter-network (topology) data transport of the relay node, which avoids the interruption of data transport.

The above ninth configuration message may be a message of the existing Xn/X2 interface, such as secondary node modification request/required message, secondary node modification acknowledge/confirm message, etc., or a newly defined message, such as inter-topology transport modification request/required message, inter-topology transport modification acknowledge/confirm message, etc.

In addition, the processes of the above four aspects may be performed separately or combined with each other. Several possible implementations are given below (for the details of each message, the description above may referred to).

Implementation 1 (Intra-CU PCell change, intra-CU PSCell addition/change, third node triggers, second node performs configuration update):
step a, the third node performs change of the PCell or addition of the PSCell or change of the PSCell, wherein the new PCell/PSCell is still the cell of the third node
step b, the third node transmits the fourth configuration message to the second node, referring to the above step 3-a-1
step c, the second node transmits the seventh configuration message to the third node, referring to the above step 3-3

Implementation 2 (Intra-CU PCell change, intra-CU PSCell addition/change, second node performs configuration update):
step a, the third node performs change of the PCell or addition of the PSCell or change of the PSCell, wherein the new PCell/PSCell is still the cell of the third node
step b, the third node transmits the fourth configuration message to the second node, referring to the above step 3-a-1
step c, the second node transmits the fourth configuration response message to the third node, referring to the above step 3-2

Implementation 3 (Inter-CU PCell change/PSCell addition/PSCell change, second node provides assistance information for selection of a target cell):
step a, the second node transmits the second configuration message to the third node, referring to the above step 1-b-1
step b, the third node and the fourth node configure the serving cell, referring to the above step 2-1/2-2/2-3
step c, the third node transmits the fourth configuration message to the second node, referring to the above step 3-a-1
step d, the second node transmits the seventh configuration message to the third node, referring to the above step 3-3, or the second node transmits the fourth configuration response message to the third node, referring to the above step 3-2

Implementation 4 (Inter-CU PCell change/PSCell addition/PSCell change, third node determines a target cell or an alternative):
step a, the third node transmits the first configuration message to the second node, referring to step 1-a-1
step b, the second node transmits the first configuration response message to the third node, referring to step 1-a-2
step c, the third node and the fourth node configure the serving cell, referring to the above step 2-1/2-2/2-3
step d, the third node transmits the fourth configuration message to the second node, referring to the above step 3-a-1
step e, the second node transmits the seventh configuration message to the third node, referring to the above step 3-3, or the second node transmits the fourth configuration response message to the third node, referring to the above step 3-2

Implementation 5 (PCell change/PSCell addition/PSCell change, first node triggers configuration update)
step a, the third node and the fourth node configure the serving cell, referring to the above step 2-1/2-2/2-3, or the third node performs change of the PCell or addition of the PSCell or change of the PSCell, wherein the new PCell/PSCell is still the cell of the third node
step b, the first node transmits the fifth configuration message to the second node, referring to step 3-b-1
step c, the second node transmits the seventh configuration message to the third node, referring to step 3-3, or the second node transmits the eighth configuration message to the fourth node, referring to step 3-5

Implementation 6 (PCell change/PSCell addition/PSCell change, fourth node triggers configuration update)
step a, the third node and the fourth node configure the serving cell, referring to the above step 2-1/2-2/2-3
step b, the fourth node transmits the sixth configuration message to the second node, referring to step 3-c-1
step c, the second node transmits the sixth configuration response message to the fourth node, referring to step 3-4, or the second node transmits the eighth configuration message to the fourth node, referring to step 3-5

Implementation 7 (PCell change/PSCell addition/PSCell change, third node triggers configuration update)
step a, the third node and the fourth node configure the serving cell, referring to the above step 2-1/2-2/2-3.
step b, the third node transmits the fourth configuration message to the second node, referring to the above step 3-a-1.
step c, the second node transmits the eighth configuration message to the fourth node, referring to step 3-5.

FIG. 15 illustrates a schematic block diagram of a device 1500 according to various embodiments of the disclosure, wherein the device may be configured to implement any one or more of the methods according to various embodiments of the disclosure. Therefore, it should be understood that the device 1500 may be the first network node or the second network node described in the disclosure, e.g., the first node, the second node, the third node, the fourth node or a part thereof described above. It should be understood that the device 1500 may be a relay node or a relay device or a part thereof, or may be a base station (e.g., a 5G base station (e.g., gNB, ng-eNB), or a 4G base station (e.g., eNB), or other types of access nodes) or a part thereof (e.g., a distributed unit DU, a central unit CU of the base station, etc.).

As shown in FIG. 15, the device 1500 includes a transceiver 1501, a processor 1502 and/or a memory 1503.

The transceiver 1501 is configured to receive and/or transmit signals.

The processor 1502 is operatively connected to the transceiver 1501 and the memory 1503. The processor 1502 may be implemented as one or more processors for operating according to any one or more of the methods described in various embodiments of the disclosure.

The memory 1503 is configured to store computer programs and data. The memory 1503 may include a non-transitory memory for storing operations and/or code instructions executable by the processor 1502. The memory 1503 may include non-transitory programs and/or instructions readable by the processor, which, when executed, cause the processor 1502 to implement the steps of any one or more of the methods according to various embodiments of the disclosure. The memory 1503 may further include a random access memory or buffer(s) to store intermediate processing data from various functions performed by the processor 1502.

Those of ordinary skill in the art will recognize that the description of the methods for node movement of the disclosure is only illustrative and is not intended to be limited in any way. Other embodiments will be readily apparent to those of ordinary skill in the art having the benefit of the disclosure.

For the sake of clarity, not all conventional features of the implementations of the methods and devices related to node movement of the disclosure are shown and described. Of course, it should be understood that in the development of any such actual implementations of the methods and devices related to node movement, in order to achieve the specific goals of the developers, such as conforming to the constraints related to applications, systems, networks and businesses, many implementation-specific decisions may need to be made, and these specific goals will vary with different implementations and developers.

The modules, processing operations and/or data structures described according to the disclosure may be implemented using various types of operating systems, computing platforms, network devices, computer programs and/or general-purpose machines. In addition, those skilled in the art will recognize that less general-purpose devices such as hard-wired devices, Field Programmable Gate Array (FPGA), Application Specific Integrated Circuits (ASIC), etc. may also be used. In the case that a method including a series of operations and sub-operations is implemented by a processor, computer or machine, and those operations and sub-operations may be stored as a series of non-transitory code instructions readable by the processor, computer or machine, they may be stored on a tangible and/or non-transitory medium.

The modules of the methods and devices related to node movement described herein may include software, firmware, hardware or any combination(s) of software, firmware or hardware suitable for the purpose described herein.

In the methods related to node movement described herein, various operations and sub-operations may be performed in various orders, and some of the operations and sub-operations may be optional.

Although the foregoing disclosure of the present application has been made by non-limiting illustrative embodiments, these embodiments may be arbitrarily modified within the scope of the appended claims without departing from the spirit and nature of the disclosure. 1-15. (canceled)

16. A method performed by a first integrated access and backhaul (IAB) donor node in a communication system, the method comprising:
receiving, from a mobile IAB node including an IAB-mobile termination (MT) and an IAB-distributed unit (DU), a gNB-DU configuration update message; and
as a response to receiving the gNB-DU configuration update message, transmitting, to a target IAB donor node, an IAB transport migration management request message,
wherein the gNB-DU configuration update message is received after a handover of the IAB-MT from a source IAB donor node to the target IAB donor node is performed.

17. The method of claim 16, wherein the first IAB donor node is associated with an F1-terminating IAB-donor node, and
wherein the target IAB donor node is associated with a radio resource control (RRC)-terminating IAB donor node.

18. The method of claim 16, wherein the gNB-DU configuration update message includes a gNB identifier (ID) of the target IAB donor node and address information of the mobile IAB node allocated by the target IAB donor node.

19. The method of claim 18, wherein the IAB transport migration management request message includes at least one the address information of the mobile IAB node or traffic information, and
wherein the traffic information includes at least one of identification information of traffic, quality of service (QoS) information of the traffic, type information of the traffic, or backhaul (BH) information of the traffic.

20. The method of claim 19, wherein the BH information includes at least one of an egress backhaul adaptation protocol (BAP) routing identifier (ID) for a downlink (DL), an egress BH radio link control (RLC) channel (CH) ID for the DL, an ingress BAP routing ID for an uplink (UL), or an ingress BH RLC CH ID for the UL.

21. A method performed by a target integrated access and backhaul (IAB) donor node in a communication system, the method comprising:
receiving, from a first IAB donor node, an IAB transport migration management request message based on a gNB-DU configuration update message,
wherein the gNB-DU configuration update message is transmitted from a mobile IAB node including an IAB-mobile termination (MT) and an IAB-distributed unit (DU) to the first IAB donor node, and
wherein the gNB-DU configuration update message is transmitted after a handover of the IAB-MT from a source IAB donor node to the target IAB donor node is performed.

22. The method of claim 21, wherein the first IAB donor node is associated with an F1-terminating IAB-donor node, and
wherein the target IAB donor node is associated with a radio resource control (RRC)-terminating IAB donor node.

23. The method of claim 21, wherein the gNB-DU configuration update message includes a gNB identifier (ID) of the target IAB donor node and address information of the mobile IAB node allocated by the target IAB donor node.

24. The method of claim 23, wherein the IAB transport migration management request message includes at least one of the address information of the mobile IAB node or traffic information, and
wherein the traffic information includes at least one of identification information of traffic, quality of service (QoS) information of the traffic, type information of the traffic, or backhaul (BH) information of the traffic.

25. The method of claim 24, wherein the BH information includes at least one of an egress backhaul adaptation protocol (BAP) routing identifier (ID) for a downlink (DL), an egress BH radio link control (RLC) channel (CH) ID for the DL, an ingress BAP routing ID for an uplink (UL), or an ingress BH RLC CH ID for the UL.

26. A first integrated access and backhaul (IAB) donor node in a communication system, the first IAB donor node comprising:
a transceiver; and
a controller coupled with the transceiver, and configured to:
receive, from a mobile IAB node including an IAB-mobile termination (MT) and an IAB-distributed unit (DU), a gNB-DU configuration update message, and
as a response to receiving the gNB-DU configuration update message, transmit, to a target IAB donor node, an IAB transport migration management request message,
wherein the gNB-DU configuration update message is received after a handover of the IAB-MT from a source IAB donor node to the target IAB donor node is performed.

27. The first IAB donor node of claim 26, wherein the first IAB donor node is associated with an F1-terminating IAB-donor node, and
wherein the target IAB donor node is associated with a radio resource control (RRC)-terminating IAB donor node.

28. The first IAB donor node of claim 26, wherein the gNB-DU configuration update message includes a gNB identifier (ID) of the target IAB donor node and address information of the mobile IAB node allocated by the target IAB donor node.

29. The first IAB donor node of claim 28, wherein the IAB transport migration management request message includes at least one of the address information of the mobile IAB node or traffic information, and
wherein the traffic information includes at least one of identification information of traffic, quality of service (QoS) information of the traffic, type information of the traffic, or backhaul (BH) information of the traffic.

30. The first IAB donor node of claim 29, wherein the BH information includes at least one of an egress backhaul adaptation protocol (BAP) routing identifier (ID) for a downlink (DL), an egress BH radio link control (RLC) channel (CH) ID for the DL, an ingress BAP routing ID for an uplink (UL), or an ingress BH RLC CH ID for the UL.

31. A target integrated access and backhaul (IAB) donor node in a communication system, the target IAB donor node comprising:
a transceiver; and
a controller coupled with the transceiver, and configured to:
receive, from a first IAB donor node, an IAB transport migration management request message based on a gNB-DU configuration update message,
wherein the gNB-DU configuration update message is transmitted from a mobile IAB node including an IAB-mobile termination (MT) and an IAB-distributed unit (DU) to the first IAB donor node, and
wherein the gNB-DU configuration update message is transmitted after a handover of the IAB-MT from a source IAB donor node to the target IAB donor node is performed.

32. The target IAB donor node of claim 31, wherein the first IAB donor node is associated with an F1-terminating IAB-donor node, and
wherein the target IAB donor node is associated with a radio resource control (RRC)-terminating IAB donor node.

33. The target IAB donor node of claim 31, wherein the gNB-DU configuration update messages includes a gNB identifier (ID) of the target IAB donor node and address information of the mobile IAB node allocated by the target IAB donor node.

34. The target IAB donor node of claim 33, wherein the IAB transport migration management request message includes at least one of the address information of the mobile IAB node or traffic information, and
wherein the traffic information includes at least one of identification information of traffic, quality of service (QoS) information of the traffic, type information of the traffic, or backhaul (BH) information of the traffic.

35. The target IAB donor node of claim 34, wherein the BH information includes at least one of an egress backhaul adaptation protocol (BAP) routing identifier (ID) for a downlink (DL), an egress BH radio link control (RLC) channel (CH) ID for the DL, an ingress BAP routing ID for an uplink (UL), or an ingress BH RLC CH ID for the UL.
